(19) United States
(12) Patent Application Publication
(10) Pub. No.: US 2004/0043132 A1
(43) Pub. Date: Mar. 4, 2004

(54) Kind of pure aquatic animal meat sausage with fish and its preparing method

(76) Inventor: Shan Wang, Beijing (CN)

Correspondence Address: LACKENBACH SIEGEL, ONE CHASE ROAD, SCARSDALE, NY, 10583, US

(21) Appl. No.: 10/416,836

(22) PCT Filed: Sep. 13, 2002
(86) PCT No.: PCT/CN02/00653

(30) Foreign Application Priority Data
Aug. 14, 2002 (CN) 0218809.7

(51) Int. Cl. A23L 1/325

(52) U.S. Cl. 426/643

(57) ABSTRACT

The present invention relates to a kind of pure aquatic animal meat sausage with fish, characterized in that using the mixture of minced cephalopod aquatic animal meat which is as a binding agent and fish meat as main material, and being prepared by conventional methods after supplement for seasonings are added to the mixture, wherein the cephalopod aquatic animal meat is 8-95% of the total weight. The present invention makes use of high binding ability of the cephalopod aquatic animal meat to overcome the defects of the fish being shaped difficultly due to its high moisture content and short fibres, and also by using cephalopod aquatic animal meat instead of animal and poultry meat in the sausage using fish meat mash as raw material, the pure aquatic animal meat sausage can be made. The present invention provides a new method for processing aquatic, can keep the original flavor and nutrition of aquatic animal to maximum extent in the sausage, so the sausage of the present invention is more delicious and better in taste than the existing aquatic animal meat sausage prepared by the fish meat mash and animal and poultry meat.

### FIELD OF THE INVENTION

The present invention relates to aquatic product process, more particularly to a kind of pure aquatic animal meat sausage with fish and its preparing method.

### BACKGROUND OF THE INVENTION

Aquatic animal meat has high nutritive value and delicate flavor, and people like to eat it. Recently, it becomes gradually a fashion to eat more aquatic products and eat less animal and poultry meat. The conventional processing methods for aquatic products include curing, smoking, tinning etc, or proceeding refrigeration transportation to meet the needs of the people who live in the place where there is no aquatic product. Recently, the technology for preparing sausage with aquatic animal meat is developed greatly, which meets people's needs to some extent. But in the prior art, the sausage is prepared by mixing the starch and animal and poultry meat with hashed or mashed aquatic animal meat, then preparing the aquatic animal meat sausage by the conventional process of preparing sausage, but with this art, there exists defects of dryness and acerbity in taste, bad elasticity, single taste, so people can not feel that there exists aquatic animal meat in the sausage when they eat the sausage. In the meantime, the sausage contains more fat and cholesterol which results from the adding of some animal and poultry meat.

### SUMMARY OF THE INVENTION

One object of the invention is to make use of the unique process and scientific formulation and the high binding ability of the cephalopod aquatic animal meat, to overcome the defects of the aquatic animal meat being shaped difficultly which results from its more moisture content and short fibres. And at the same time, the invention can use cephalopod aquatic animal meat instead of animal and poultry meat in the sausage using fish meat mash as raw material, combine the aquatic process with conventional meat process. The present invention gets rid of the conventional method in preparing aquatic animal meat sausage by adding animal and poultry meat as binding agent, and prepares a kind of tasteful and nutritive pure aquatic animal meat sausage with fish. The present invention can be used in large scale, and the source of raw materials used in the invention are more, and the invention provides a new method for aquatic product processing.

Another object of the invention is to keep the original nutrition and flavor of aquatic to maximum extent in the sausage by using aquatic animal meat having a certain shape as raw material and cooking at low temperature, so that the sausage of the present invention is more delicious and better in taste than the aquatic animal meat sausage prepared by the fish meat mash and animal and poultry meat. Thus the aquatic animal meat sausage will be a kind of true and tasteful aquatic animal meat sausage with fish and people can appreciate the existence of the aquatic animal meat.

In accordance with the present invention, one method of achieving aforesaid purpose includes steps: selecting minced cephalopod aquatic animal meat as binding agent, mixing it with fish meat, adding seasonings as supplement, and then preparing pure aquatic animal meat sausage containing fish by conventional methods, wherein the cephalopod aquatic animal meat is 8-95% of the total weight, preferably 25-60%, more preferably 30-50%, of the total weight.

The cephalopod aquatic includes Todarodes pacificus, Sepia esculenta, Loligo japonica, Sepiella maindroni, Doryteuthis bleekeri, Sepioteuthis lessoniana, Octopus variabilis, Octopus ochellatus and Octopus vulgaris.

The process of cephalopod aquatic animal meat described above includes steps: selecting a certain amount of cephalopod aquatic animal meat to be rough processed, removing inedible portion, then cutting edible portion into block, strip, slice or particle with length of 1-100 mm, width of 1-100 mm and thickness of 2-40 mm; then curing them with suitable amount of seasonings for 2-48 hours; the said seasonings used in curing process include soya sauce, spicery, ground spices, paprika powder, etc.

The preparing method for the aforesaid pure aquatic animal meat sausage with fish includes steps: mixing the processed cephalopod aquatic animal meat with fish meat, and adding supplement according to different taste by conventional technology, the weight ratio of the supplement is: soya sauce 0-8, refined salt 0.5-5, sugar 1-10, soya protein or starch 0-8, carrageenan 1-5, spicery 0.01-5, thickener 0.01-5, mixing the above materials uniformly and filling the mixture into animal casing or simulation casing, and then low-temperature steaming, cooking, smoking, or roasting to obtain the sausage.

Aforesaid fish can be fish meat mash or fish block, in which fish meat mash can be processed by conventional method, and the preparing method of the fish block include steps: selecting a certain amount of fish, removing head, gut and scale of the fish, then salting the fish with salt or curing the fish with suitable amount of seasonings, drying the salted or cured fish by airing in shady and cool place or by heating, steaming the dried fish for 15-30 minutes, removing fish bone and foreign materials after cooling, and then cutting the fish into block, strip or slice with length of 1-100 mm, width of 1-100 mm,and thickness of 2-40 mm.

The fish block can also be processed by steps as follows: curing the fish with water, salt and spicery for 0.5-12 hours, steaming and then removing inedible portion, cutting edible portion into block, strip or slice with length of 1-100 mm, thickness of 2-40 mm,. and width of 1-100 mm.

The fish block can be raw, ready-cooked, smoked and/or dried, and the shape of it can be monoblock, strip or slice; the size of it can be 1-100 mm in length, 2-40 mm in thickness and 1-100 mm in width.

The advantages of the present invention include: remaining the original flavor and nutrition of aquatic animal meat, being better in taste and having more nutrition than conventional aquatic animal meat sausage using fish meat mash and animal and poultry meat as raw material. So the aquatic animal meat sausage of the present invention is the true aquatic meat sausage not only being tasteful but also people can appreciate the existence of the aquatic animal meat, which fill the vacancy of the market.

The present invention overcomes the defects of aquatic animal meat being shaped difficultly which result from its short fibres and more moisture content; and in the meantime, the present invention can be used in large scale, and the source of the raw material used in the invention is broad, and the invention provides a new method for processing aquatic product.

The present invention combines the advantages of tastefulness, high nutritive value from aquatic animal meat with the advantages of easy to preserve and carry, convenience for eating, unique in taste from the conventional sausage, and provides a new convenience food. Furthermore, the present invention can provide different taste, so it can satisfy different demands of consumer. The present invention can solve the problem that some consumers like to eat aquatic animal meat but aren't expert in cooking.

### DETAILED DESCRIPTION OF THE PREFERRING EMBODIMENTS

The present invention now will be further explained by the following examples.

### EXAMPLE 1

Selecting processed hairtail meat 60kg and Todarodes pacificus (squid) 40 kg, cutting into block having length of 2-100 mm, adding salt 2.7 kg, sugar 2 kg, soya protein 6 kg, spicery 0.2 kg, cooking wine 1 kg, mixing them uniformly, filling the mixture into animal casing under vacuum, drying, and then low-temperature steaming and smoking to obtain the roasted fish sausage according to the invention.

### EXAMPLE 2

Selecting processed pomfret meat 70 kg and Todarodes pacificus (squid) 30 kg, cutting into block having length of 1-100 mm, adding salt 2.7 kg, sugar 2 kg, soya protein 6 kg, spicery 0.2 kg, cooking wine 1 kg, mixing them uniformly, filling the mixture into animal casing under vacuum, drying, and then low-temperature steaming and smoking to obtain the roasted fish sausage according to the invention.

### EXAMPLE 3

Selecting processed hairtail meat 92 kg and cuttlefish 8 kg, cutting into block having length of 2-90 mm, adding salt 2.7 kg, sugar 2 kg, soya protein 6 kg, spicery 0.2 kg, cooking wine 1 kg, mixing them uniformly, filling the mixture into animal casing under vacuum, drying, and then low-temperature steaming and smoking to obtain roasted fish sausage according to the invention.

### EXAMPLE 4

Selecting processed yellow croaker (yellow-tin tuna ) meat 50 kg, cuting into block having length of 1-90 mm, and Octopus variabilis meat block 50 kg, adding soya sauce 4 kg, salt 3.5 kg, sugar 2.5 kg, cooing wine 1.5 kg, spicery 0.5 kg, mixing them uniformly, filling the mixture into animal casing, drying by airing in shady and cool place for 5-20 days, and then low-temperature steaming to obtain the Chinese-style pure fish sausage.

### EXAMPLE 5

Selecting processed yellow croaker (yellow-tin tuna ) meat 5 kg, cutting into block having length of 1-90 mm, and Todarodes pacificus (squid) meat block 95 kg, adding soy sauce 4 kg, salt 3.5 kg, sugar 2.5 kg, cooking wine 1.5 kg, spicery 0.5 kg, mixing them uniformly, filling the mixture into animal casing, drying by airing in shady and cool place for 5-20 days, and then low-temperature steaming to obtain the Chinese-style pure fish sausage.

It can be seen from aforesaid examples that the sausage of the present invention includes sausage, roasted sausage, smoked sausage and hot dog.

Practical Applicability

The present invention combines the advantages of tastefulness, high nutritive value from aquatic product with the advantages of easy to preserve and carry, convenience for eating, unique in taste from the conventional sausage, and provides a new convenience food. Furthermore, the product of the present invention can be ate conveniently, and is helpful to people's health because of its high nutritive value.

1. A kind of pure aquatic animal meat sausage with fish, characterized in that: using the mixture of minced cephalopod aquatic animal meat which is as a binding agent and fish meat as main material, and being prepared by conventional methods after seasonings for supplement are added to the mixture, wherein the cephalopod aquatic animal meat is 8-95% of the total weight.

2. A kind of pure aquatic animal meat sausage with fish according to claim 1, wherein the cephalopod aquatic animal meat is 30-50% of the total weight.

3. A kind of pure aquatic animal meat sausage with fish according to claim 1 or claim 2, wherein the said cephalopod aquatic animal includes Todarodes pacificus, Sepia esculenta, Loligo japonica, Sepiella maindroni, Doryteuthis bleekeri, Sepioteuthis lessoniana, Octopus variabilis, Octopus ochellatus and Octopus vulgaris.

4. A kind of pure aquatic animal meat sausage with fish according to claim 1 or claim 2, wherein the process of the cephalopod aquatic animal meat includes steps: rough processing, removing inedible portion, then cutting edible portion into block, strip, slice or particle with length of 1-100 mm, width of 1-100 mm and thickness of 2-40 mm; then curing them with suitable amount of seasonings for 2-48 hours.

5. A kind of pure aquatic animal meat sausage with fish according to claim 1 or claim 2, wherein said fish is fish meat mash or fish block.

6. A kind of pure aquatic animal meat sausage with fish according to claim 5, in which the method for preparing said fish block includes steps: selecting a certain amount of fish, removing head, gut, and scale, then salting the fish with salt or curing the fish with seasonings, drying the salted or cured fish by airing in shady and cool place or by heating, steaming the dried fish for 15-30 minutes, removing fish bone and foreign materials after cooling, and then cutting the fish into block, strip or slice with length of 1-100 mm, thickness of 2-40 mm and width of 1-100 mm.

7. A kind of pure aquatic animal meat sausage with fish according to claim 5, in which the method for preparing said fish block includes steps: rough processing, removing head, gut and scale, curing the fish with water, salt and spicery for 0.5-12 hours, removing inedible portion after steaming, and then cutting the fish into block, strip or slice with length of 1-100 mm, thickness of 2-40 mm and width of 1-100 mm.

8. A kind of pure aquatic animal meat sausage with fish according to claim 6 or claim 7, in which the said fish block can be raw, ready-cooked, smoked and/or dried product.

9. A kind of pure aquatic animal meat sausage with fish according to claim 1 or claim 2, in which the weight ratio of supplement is: refined salt 0.5-5, soya sauce 0-8, sugar 1-10, soya protein or starch 0-8, carrageenan 1-5, spicery 0.01-5, thickener 0.01-5.

10. A method for preparing the pure aquatic animal meat sausage with fish according to claim 1 or claim 2, characterized in that: selecting a certain amount of cephalopod aquatic animal meat, removing inedible portion, cutting edible portion into block, strip or slice with length of 1-100 mm, thickness of 2-40 mm and width of 1-100 mm, then curing the fish with suitable amount of seasonings for 2-48 hours, mixing the processed cephalopod aquatic animal meat with the fish meat, in which the cephalopod aquatic animal meat is 8-95% of the total weight; and then adding the supplement in light of different taste, mixing them uniformly and filling the mixture into animal casing or simulation casing, and steaming, cooking, smoking or roasting to obtain sausage, roasted sausage or smoked sausage respectively by conventional technology.
